(19) United States
(12) Patent Application Publication
(10) Pub. No.: US 2013/0082947 A1
(43) Pub. Date: Apr. 4, 2013

(54) TOUCH DEVICE, TOUCH SYSTEM AND TOUCH METHOD

(71) Applicant: Yao-Tsung Chang, New Taipei City (TW)

(72) Inventor: Yao-Tsung Chang, New Taipei City (TW)

(21) Appl. No.: 13/535,310

(22) Filed: Jun. 27, 2012

(30) Foreign Application Priority Data
Oct. 4, 2011 (TW) 100135969

(51) Int. Cl. G06F 3/041

(52) U.S. Cl. 345/173

(57) ABSTRACT

A touch device includes N touch areas, N−1 non-touch areas and a processing unit. An i-th non-touch area of the N−1 non-touch areas is located between an i-th touch area and an (i+1) -th touch area of the N touch areas. When a first operation gesture is performed from the i-th touch area to the (i+1)-th touch area across the i-th non-touch area, the processing unit receives a first touch signal from the i-th touch area within a first time interval, does not receive any touch signal within a second time interval, and receives a second touch signal from the (i+1)-th touch area within a third time interval . When the processing unit determines that the second time interval is smaller than a first threshold, the processing unit executes a first command corresponding to the first operation gesture according to the first and second touch signals.

### BACKGROUND OF THE INVENTION

1. Field of the Invention

The invention relates to a touch device, a touch system and a touch method and, more particularly, to a touch device, a touch system and a touch method capable of integrating a plurality of touch areas into one larger touch area.

2. Description of the Prior Art

Since consumer electronic products have become more and more lighter, thinner, shorter, and smaller, there is no space on these products for containing a conventional input device, such as a mouse, a keyboard, etc. With development of touch technology, in various kinds of consumer electronic products (e.g. a tablet personal computer, a mobile phone, a personal digital assistant (PDA), or an all-in-one device), a touch device has become a main tool for data input.

In general, the touch device is disposed directly on a display panel. Currently, some electronic devices have a plurality of display panels and each of the display panels is equipped with one touch device thereon correspondingly. However, a user can only perform independent operation gesture on each of the touch devices so as to execute touch function correspondingly. When the user performs an operation gesture from one touch device to another touch device, no touch function can be executed. Since those touch devices cannot be integrated into one larger touch device, the application of the touch device will be restricted.

### SUMMARY OF THE INVENTION

The invention provides a touch device, a touch system and a touch method capable of integrating a plurality of touch areas into one larger touch area, so as to solve the aforesaid problems.

According to an embodiment, a touch device of the invention comprises N touch areas, N−1 non-touch areas and a processing unit, wherein N is a positive integer larger than 1 and the processing unit is electrically connected to the N touch areas. An i-th non-touch area of the N−1 non-touch areas is located between an i-th touch area and an (i+1) -th touch area of the N touch areas, wherein i is a positive integer smaller than N. When a first operation gesture is performed from the i-th touch area to the (i+1) -th touch area across the i-th non-touch area, the processing unit receives a first touch signal from the i-th touch area within a first time interval, does not receive any touch signal within a second time interval, and receives a second touch signal from the (i+1) -th touch area within a third time interval . When the processing unit determines that the second time interval is smaller than a first threshold, the processing unit executes a first command corresponding to the first operation gesture according to the first and second touch signals.

According to another embodiment, a touch method of the invention comprises performing a first operation gesture on the touch device, wherein the touch device comprises N touch areas and N−1 non-touch areas, an i-th non-touch area of the N−1 non-touch areas is located between an i-th touch area and an (i+1) -th touch area of the N touch areas, the first operation gesture is performed from the i-th touch area to the (i+1) -th touch area across the i-th non-touch area, N is a positive integer larger than 1, and i is a positive integer smaller than N; receiving a first touch signal from the i-th touch area within a first time interval; not receiving any touch signal within a second time interval; receiving a second touch signal from the (i+1)-th touch area within a third time interval; and executing a first command corresponding to the first operation gesture according to the first and second touch signals when the second time interval is smaller than a first threshold.

According to another embodiment, a touch system of the invention comprises a first touch device and a second touch device. The first touch device comprises a first touch area, a first processing unit and a first communicating unit, wherein the first processing unit is electrically connected to the first touch area and the first communicating unit. The second touch device comprises a second touch area, a second processing unit and a second communicating unit, wherein the second processing unit is electrically connected to the second touch area and the second communicating unit, and the second communicating unit communicates with the first communicating unit. The second touch device is arranged adjacent to the first touch device such that a non-touch area is located between the first touch area and the second touch area. When a first operation gesture is performed from the first touch area to the second touch area across the non-touch area, the first processing unit receives a first touch signal from the first touch area within a first time interval, the first and second processing units do not receive any touch signal within a second time interval, and the second processing unit receives a second touch signal from the second touch area within a third time interval. When the first and second processing units determine that the second time interval is smaller than a first threshold, the first and second processing units execute a first command corresponding to the first operation gesture according to the first and second touch signals.

According to another embodiment, a touch method of the invention comprises enabling a first touch device to communicate with a second touch device, wherein the first touch device comprises a first touch area, the second touch device comprises a second touch area, and the second touch device is arranged adjacent to the first touch device such that a non-touch area is located between the first touch area and the second touch area; performing a first operation gesture on the first and second touch devices, wherein the first operation gesture is performed from the first touch area to the second touch area across the non-touch area; receiving a first touch signal from the first touch area within a first time interval; not receiving any touch signal within a second time interval; receiving a second touch signal from the second touch area within a third time interval; and executing a first command corresponding to the first operation gesture according to the first and second touch signals when the second time interval is smaller than a first threshold.

As mentioned in the above, when the first operation gesture crosses the non-touch area, the touch device will not receive any touch signals within the second time interval. The touch device, the touch system and the touch method of the invention utilize the second time interval to determine whether the first operation gesture is a continuous operation gesture. If the second time interval is smaller than the first threshold (e.g. 0.5 second), the first operation gesture is determined as a continuous operation gesture. Then the first command corresponding to the first operation gesture will be executed according to the touch signals from different touch areas. On the other hand, if the second time interval is not smaller than the first threshold (e.g. 0.5 second), the first operation gesture is determined as a discontinuous operation gesture. And no command will be executed. Accordingly, the plurality of touch areas on the touch device or the touch system can be integrated into one larger touch area.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a top view of a touch device according to an embodiment of the invention.

FIG. 2 is a schematic diagram illustrating a side view of the touch device shown in FIG. 1.

FIG. 3 is a functional block diagram illustrating the touch device shown in FIG. 1.

FIG. 4 is a flowchart illustrating a touch method according to an embodiment of the present invention.

FIG. 5 is a flowchart illustrating a touch method according to another embodiment of the invention.

FIG. 6 is a flowchart illustrating a touch method according to another embodiment of the present invention.

FIG. 7 is a schematic diagram illustrating a second operation gesture and a third operation gesture performed on two touch areas respectively.

FIG. 8 is a schematic diagram illustrating a top view of a touch device according to another embodiment of the invention.

FIG. 9 is a schematic diagram illustrating a side view of the touch device shown in FIG. 8.

FIG. 10 is a functional block diagram illustrating the touch device shown in FIG. 8.

FIG. 11 is a schematic diagram illustrating a top view of a touch device according to another embodiment of the invention.

FIG. 12 is a functional block diagram illustrating the touch device shown in FIG. 11.

FIG. 13 is a schematic diagram illustrating a top view of a touch device according to another embodiment of the invention.

FIG. 14 is a schematic diagram illustrating a top view of a touch device according to another embodiment of the present invention.

FIG. 15 is a schematic diagram illustrating a top view of a touch system according to another embodiment of the present invention.

FIG. 16 is schematic diagram illustrating a side view of the touch system shown in FIG. 15.

FIG. 17 is a functional block diagram illustrating the touch system shown in FIG. 15.

FIG. 18 is a flowchart illustrating a touch method according to another embodiment of the present invention.

FIG. 19 is a flowchart illustrating a touch method according to another embodiment of the present invention.

FIG. 20 is a flowchart illustrating a touch method according to another embodiment of the present invention.

### DETAILED DESCRIPTION

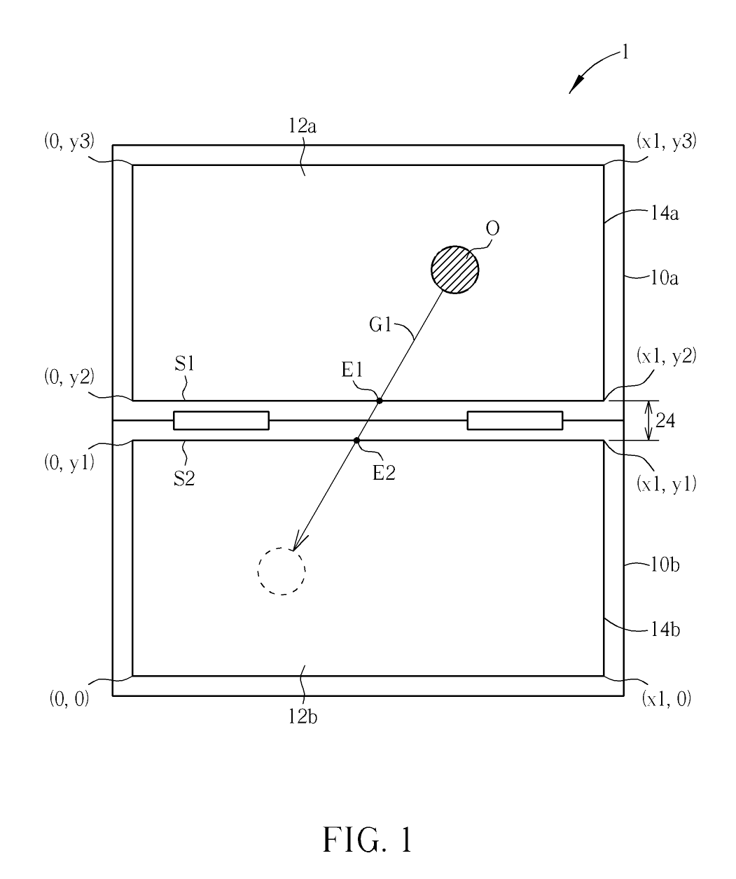

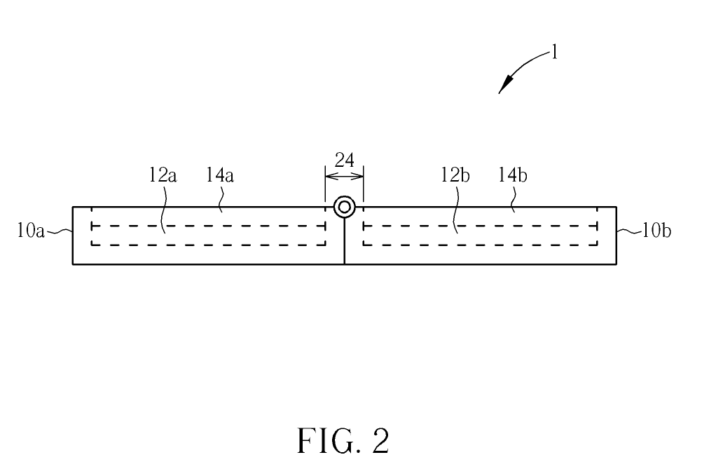

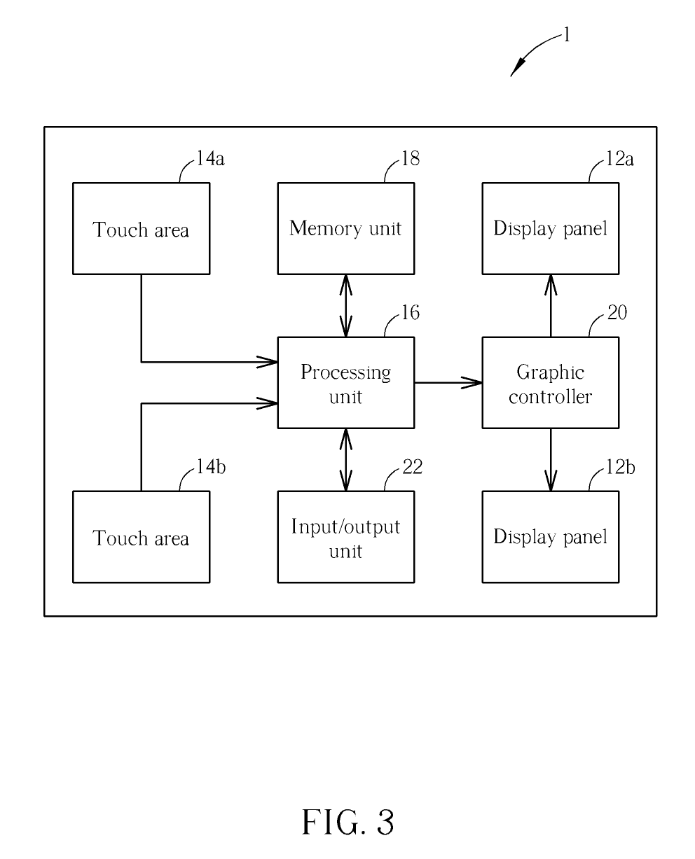

Referring to FIGS. 1 to 3, FIG. 1 is a schematic diagram illustrating a top view of a touch device 1 according to an embodiment of the invention, FIG. 2 is a schematic diagram illustrating a side view of the touch device 1 shown in FIG. 1, and FIG. 3 is a functional block diagram illustrating the touch device 1 shown in FIG. 1. As shown in FIGS. 1 to 3, the touch device 1 comprises casings 10a, 10b, display panels 12a, 12b, touch areas 14a, 14b, a processing unit 16, a memory unit 18, a graphic controller 20 and an input/output unit 22. In this embodiment, the display panels 12a, 12b may be liquid crystal displays or other displays, the touch areas 14a, 14b may be piezoelectric touch devices, resistance touch devices, capacitance touch devices or other touch devices, the processing unit 16 may be a processor or a controller capable of calculating or processing data, the memory unit 18 may be a non-volatile memory, volatile memory or other data storage devices.

The casings 10a, 10b are pivotally connected to each other so that the casings 10a, 10b can rotate with respect to each other so as to be folded or expanded. The display panel 12a is disposed in the casing 10a and the touch area 14a is disposed on the display panel 12a. The display panel 12b is disposed in the casing 10b and the touch area 14b is disposed on the display panel 12b. The processing unit 16, the memory unit 18, the graphic controller 20 and the input/output unit 22 may be selectively disposed in the casing 10a or the casing 10b. The processing unit 16 is electrically connected to the touch areas 14a, 14b, the memory unit 18, the graphic controller 20 and the input/output unit 22 and is electrically connected to the display panels 12a, 12b through the graphic controller 20. In this embodiment, the display panels 12a, 12b are used for displaying images; the touch areas 14a, 14b are used for sensing operation gestures performed by a user; the processing unit 16 is used for executing programs stored in the memory unit 18, receiving touch signals from the touch areas 14a, 14b, and controlling the graphic controller 20 to display images on the display panels 12a, 12b; the memory unit 18 is used for storing necessary programs or data for the touch device 1; the graphic controller 20 is used for generating images and then displaying the images on the display panels 12a, 12b; and the input/output unit 22 is used for communicating with external input/output device in wired or wireless manner.

As shown in FIGS. 1 and 2, a non-touch area 24 is located between the touch areas 14a, 14b since the touch areas 14a, 14b are disposed on the casings 10a, 10b respectively. It should be noted that this embodiment utilizes two touch areas 14a, 14b and one non-touch area 24 to describe the feature of the invention. However, in practical applications, N touch areas may be disposed on the touch device 1 of the invention, wherein N is a positive integer larger than 1. Furthermore, N−1 non-touch areas may be formed on the touch device 1 and used for separating the N touch areas. In other words, the i-th non-touch area of the N−1 non-touch areas is located between the i-th touch area and the (i+1) -th touch area of the N touch areas, wherein i is a positive integer smaller than N. As shown in FIGS. 1 and 2, the touch area 14a is the first touch area, the touch area 14b is the second touch area, and the non-touch area 24 is the first non-touch area located between the touch area 14a and the touch area 14b (i.e. N=2 and i=1).

In practical applications, the invention may set specific coordinates on the touch areas 14a, 14b and the non-touch area 24 for purpose of touch determination. As shown in FIG. 1, the coordinates of four corners of the touch area 14b are represented by (0,0), (x1,0), (0,y1) and (x1,y1), the coordinates of four corners of the non-touch area 24 are represented by (0,y1), (x1,y1), (0,y2) and (x1,y2), and the coordinates of four corners of the touch area 14a are represented by (0,y2), (x1,y2), (0,y3) and (x1,y3).

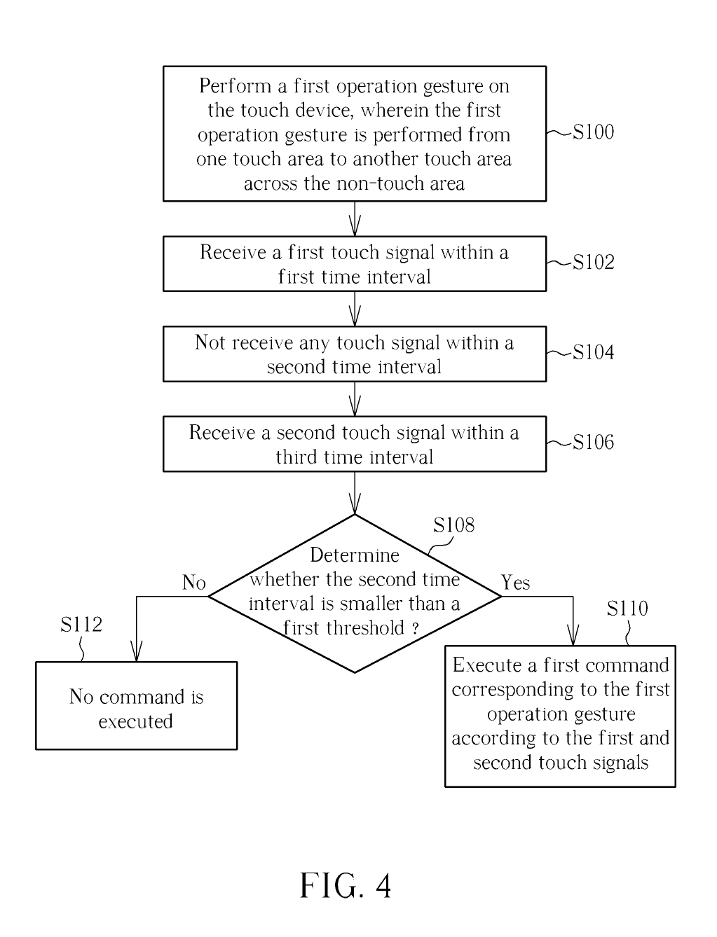

Referring to FIG. 4, FIG. 4 is a flowchart illustrating a touch method according to an embodiment of the present invention. The touch method shown in FIG. 4 may be implemented by programming. The touch device 1 shown in FIGS. 1 to 3 together with the touch method shown in FIG. 4 will be used to describe the features of this embodiment in the following. First of all, step S100 is executed to perform a first operation gesture G1 on the touch device 1, wherein the first operation gesture G1 is performed from the touch area 14a to the touch area 14b across the non-touch area 24. When the first operation gesture G1 is performed from the touch area 14a to the touch area 14b across the non-touch area 24, the processing unit 16 receives a first touch signal from the touch area 14a within a first time interval (step S102), does not receive any touch signal within a second time interval (step S104), and receives a second touch signal from the touch area 14b within a third time interval (step S106). In step S102, the first time interval represents the needed time when the first operation gesture G1 moves over the touch area 14a. In step S104, the second time interval represents the needed time when the first operation gesture G1 moves over the non-touch area 24. In step S106, the third time interval represents the needed time when the first operation gesture G1 moves over the touch area 14b. Afterward, in step S108, the processing unit 16 determines whether the second time interval is smaller than a first threshold (e.g. 0.5 second). When the processing unit 16 determines that the second time interval is smaller than the first threshold, the processing unit 16 executes a first command corresponding to the first operation gesture G1 according to the first and second touch signals (step S110). As shown in FIG. 1, the first command is executed to move an object O from the display panel 12a to the display panel 12b (as the dotted line shown in FIG. 1). On the other hand, if the processing unit 16 determines that the second time interval is not smaller than the first threshold, no command is executed (step S112).

As mentioned in the above, when the first operation gesture G1 crosses the non-touch area 24, the processing unit 16 does not receive any touch signal within the second time interval. The touch device 1 and the touch method of the present invention determine whether the first operation gesture G1 is a continuous operation gesture based on the second time interval. If the first operation gesture G1 is determined as a continuous operation gesture, the first command corresponding to the first operation gesture G1 is executed according to the touch signals from different touch areas correspondingly. On the other hand, if the first operation gesture G1 is determined as a discontinuous operation gesture, no command is executed correspondingly. Therefore, a plurality of touch areas of the touch device 1 can be integrated into one larger touch area.

It should be noted that the first operation gesture G1 and the corresponding first command can be designed based on practical applications and are not limited to the aforesaid embodiment.

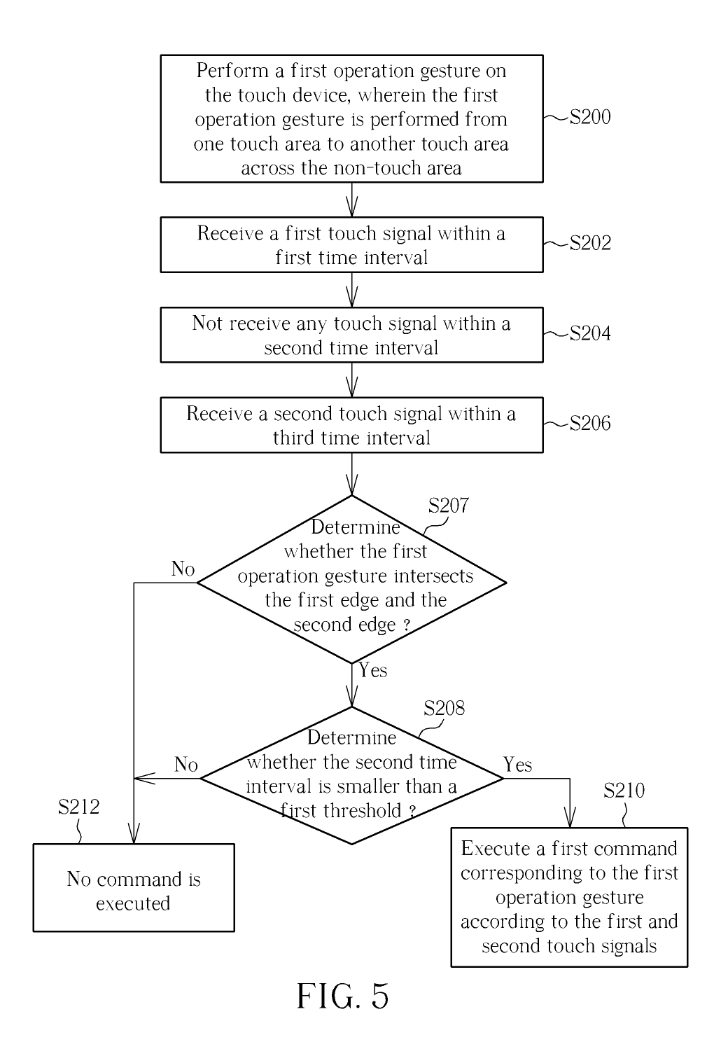

Referring to FIG. 5, FIG. 5 is a flowchart illustrating a touch method according to another embodiment of the invention. The touch method shown in FIG. 5 may be implemented by programming. The touch device 1 shown in FIGS. 1 to 3 together with the touch method shown in FIG. 5 will be used to describe the features of this embodiment in the following. As shown in FIG. 1, the non-touch area 24 abuts against a first edge S1 of the touch area 14a and abuts against a second edge S2 of the touch area 14b. Steps S200-S206 shown in FIG. 5 are substantially the same as steps S100-S106 shown in FIG. 4 and are not depicted herein again. After step S206, the processing unit 16 determines whether the first operation gesture G1 intersects the first edge S1 and the second edge S2 (step S207). If the first operation gesture G1 intersects the first edge S1 and the second edge S2, step S208 is then executed. On the other hand, if the first operation gesture G1 does not intersect the first edge S1 or the second edge S2, step S212 is then executed. Steps S208-S212 shown in FIG. 5 are substantially the same as steps S108-S112 shown in FIG. 4 and are not depicted herein again.

In other words, the touch method shown in FIG. 5 determines whether the first operation gesture G1 is a continuous operation gesture based on the second time interval and whether the first operation gesture G1 intersects the first edge S1 and the second edge S2, so as to determine whether to execute the first command.

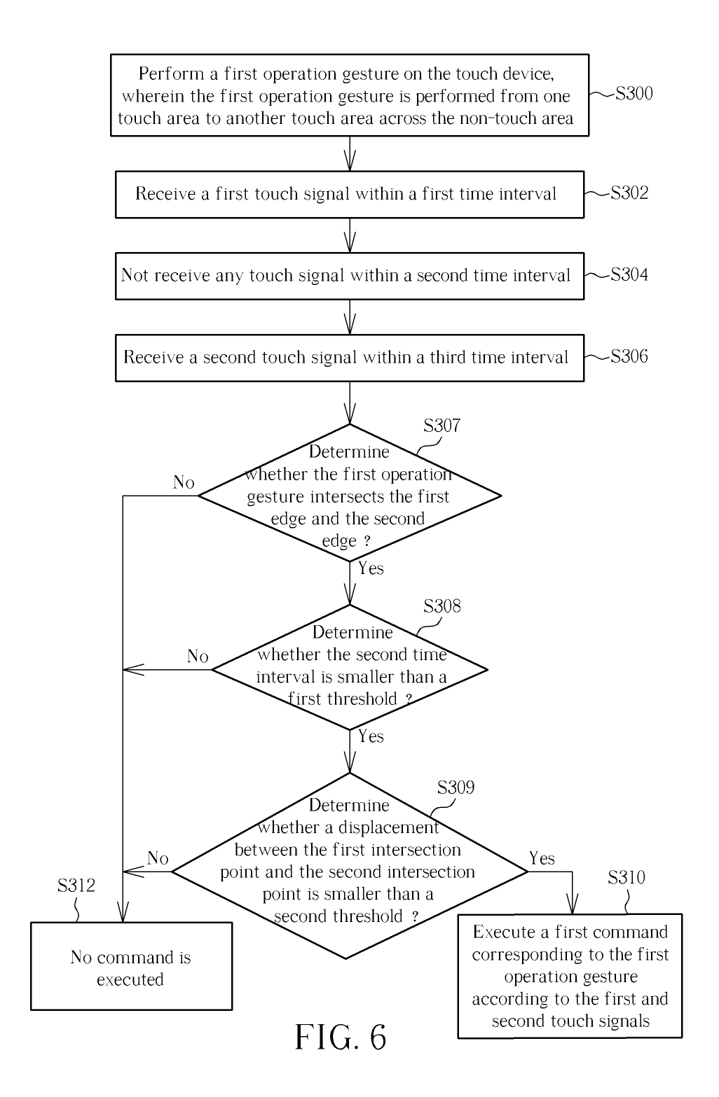

Referring to FIG. 6, FIG. 6 is a flowchart illustrating a touch method according to another embodiment of the present invention. The touch method shown in FIG. 6 may be implemented by programming. The touch device 1 shown in FIGS. 1 to 3 together with the touch method shown in FIG. 6 will be used to describe the features of this embodiment in the following. As shown in FIG. 1, the first operation gesture G1 intersects the first edge S1 at a first intersection point El and intersects the second edge S2 at a second intersection point E2. Steps S300-S308 shown in FIG. 6 are substantially the same as steps S200-S208 shown in FIG. 5 and are not depicted herein again. After step S308, the processing unit 16 determines whether a displacement between the first intersection point El and the second intersection point E2 is smaller than a second threshold (e.g. 3 mm) in step S309. If the displacement between the first intersection point El and the second intersection point E2 is smaller than the second threshold, step S310 is then executed. On the other hand, if the displacement between the first intersection point El and the second intersection point E2 is not smaller than the second threshold, step S312 is then executed. Steps S310-S312 shown in FIG. 6 are substantially the same as steps S210-S212 shown in FIG. 5 and are not depicted herein again.

In other words, the touch method shown in FIG. 6 determines whether the first operation gesture G1 is a continuous operation gesture based on the second time interval, whether the first operation gesture G1 intersects the first edge S1 and the second edge S2, and the displacement between the first intersection point E1 and the second intersection point E2, so as to determine whether to execute the first command.

It should be noted that once the touch area 14a is very close to the touch area 14b (i.e. the non-touch area 24 is very small), the first operation gesture G1 across the non-touch area 24 may contact the first edge S1 and the second edge S2 simultaneously. At this time, the aforesaid second time interval may be substantially equal to zero.

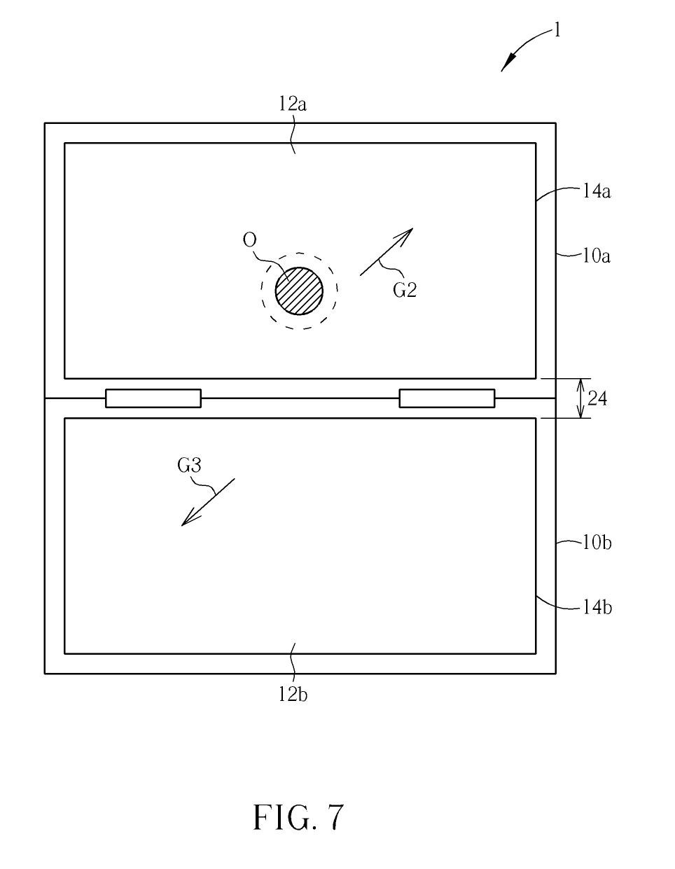

Referring to FIG. 7, FIG. 7 is a schematic diagram illustrating a second operation gesture G2 and a third operation gesture G3 performed on the touch area 14a and the touch area 14b respectively. As shown in FIG. 7, the second operation gesture G2 and the third operation gesture G3 are moving gestures. When the second operation gesture G2 is performed on the touch area 14a and the third operation gesture G3 is performed on the touch area 14b, the processing unit 16 receives a third touch signal from the touch area 14a and a fourth touch signal from the touch area 14b simultaneously and executes a second command corresponding to the second operation gesture G2 and the third operation gesture G3 according to the third and fourth touch signals. As shown in FIG. 7, for example, since the second operation gesture G2 and the third operation gesture G3 move away from each other, the second command is executed to zoom in an object O on the display panel 12a (as the dotted line shown in FIG. 7). Similarly, if the second operation gesture G2 and the third operation gesture G3 move close to each other, the second command is executed to zoom out the object O on the display panel 12a.

It should be noted that the second operation gesture G2, the third operation gesture G3 and the corresponding second command can be designed based on practical applications and are not limited to the aforesaid embodiment.

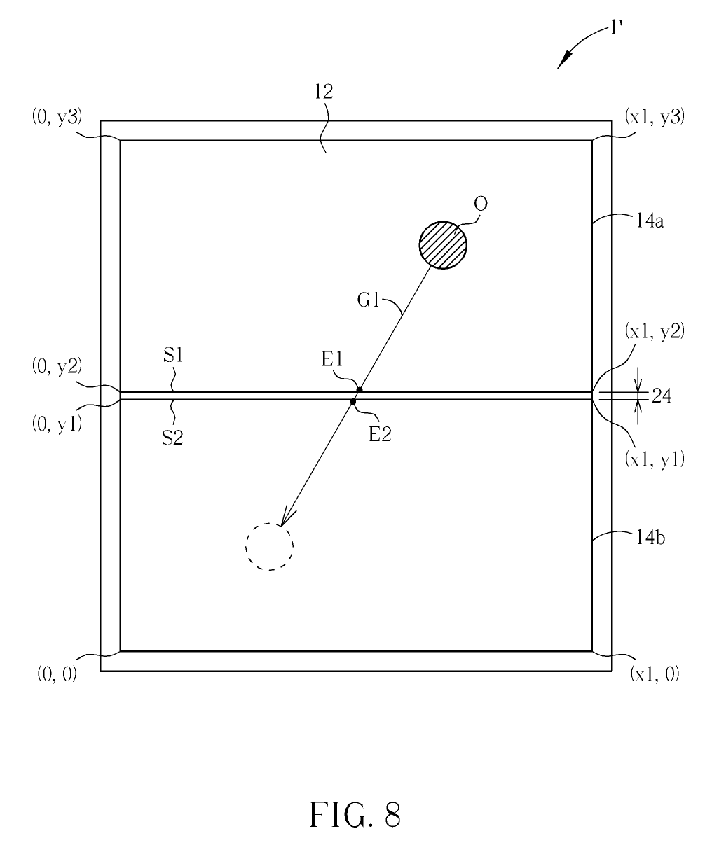

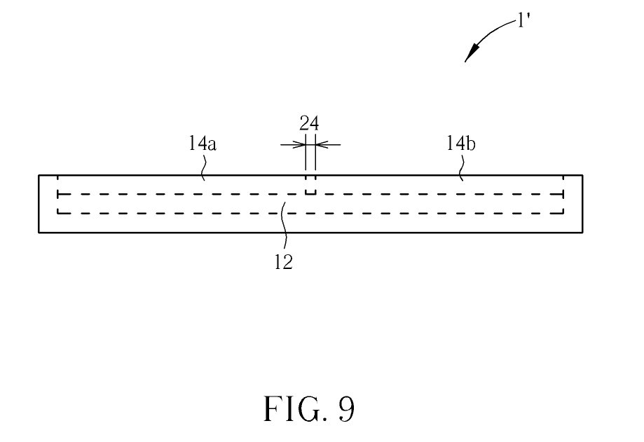

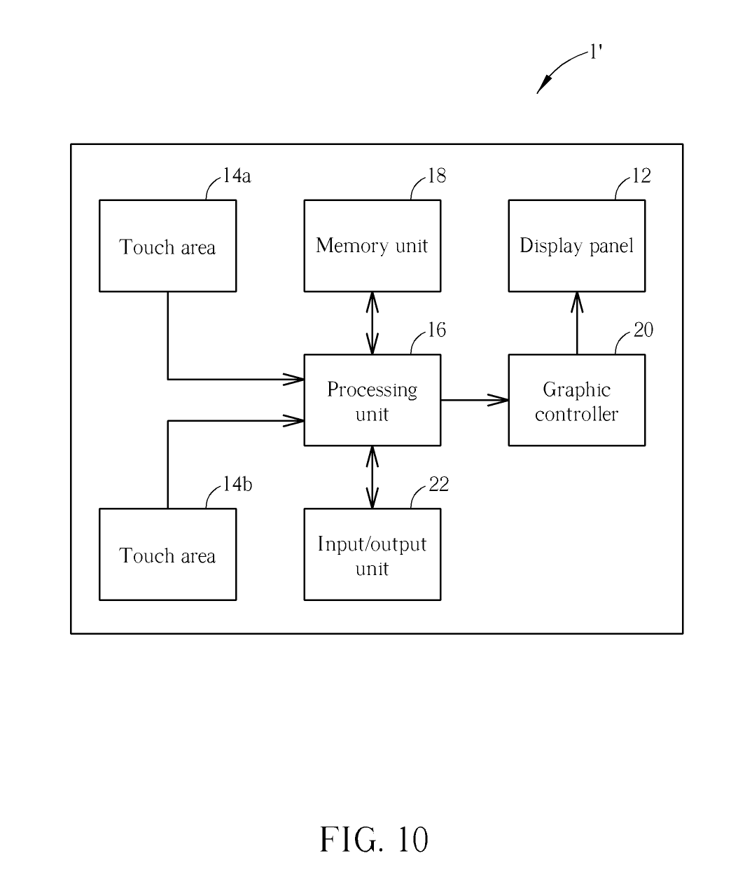

Referring to FIGS. 8 to 10, FIG. 8 is a schematic diagram illustrating a top view of a touch device 1′ according to another embodiment of the invention, FIG. 9 is a schematic diagram illustrating a side view of the touch device 1′ shown in FIG. 8, and FIG. 10 is a functional block diagram illustrating the touch device 1′ shown in FIG. 8. The main difference between the touch device 1′ and the aforesaid touch device 1 is that the touch device 1′ comprises one single display panel 12 and the touch areas 14a, 14b are disposed on the display panel 12. Once the size of one single touch area cannot be manufactured the same as that of the display panel 12, a plurality of touch areas has to be disposed on the display panel 12 so as to cover a display region of the display panel 12. As shown in FIGS. 8 and 9, the non-touch area 24 is located between the touch area 14a and the touch area 14b. It should be noted that the same elements in FIGS. 8-10 and FIGS. 1-3 are represented by the same numerals, so the repeated explanation will not be depicted herein again.

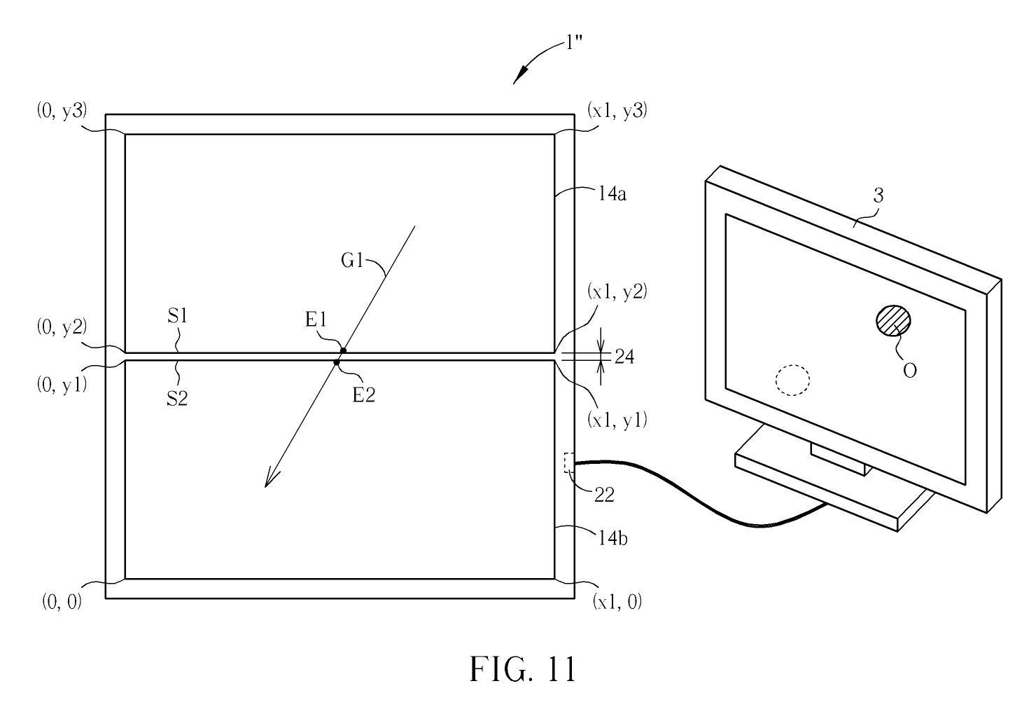

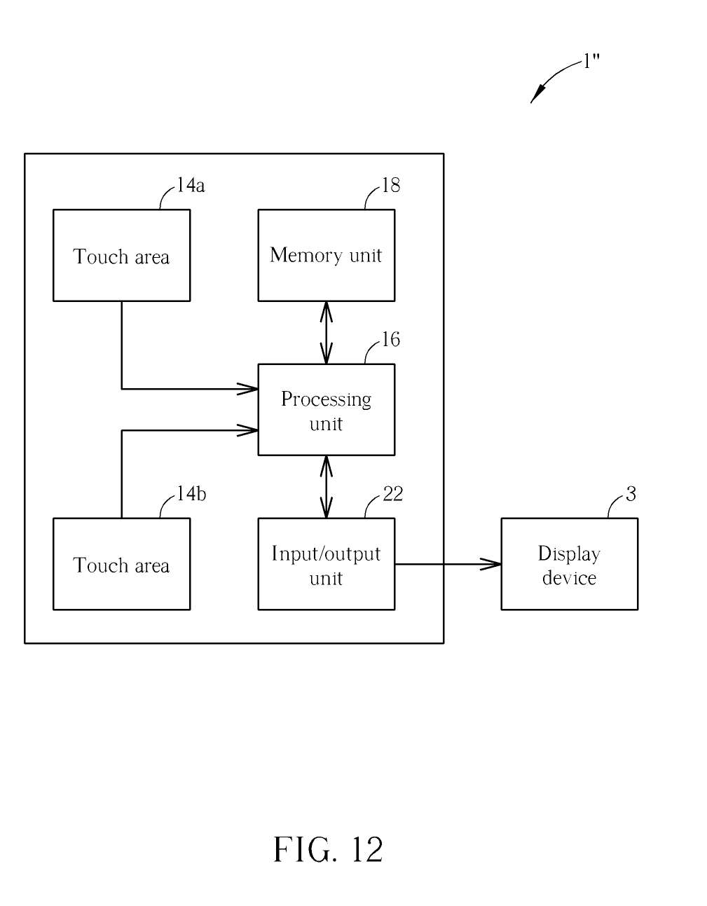

Referring to FIGS. 11 and 12, FIG. 11 is a schematic diagram illustrating a top view of a touch device 1″ according to another embodiment of the invention, and FIG. 12 is a functional block diagram illustrating the touch device 1″ shown in FIG. 11. The main difference between the touch device 1″ and the aforesaid touch device 1 is that the touch device 1″ does not comprise display panel and graphic controller and utilize the input/output unit 22 to communicate with an external display device 3. When a user performs an operation gesture on the touch areas 14a, 14b of the touch device 1″, the processing unit 16 transmits touch signals to the display device 3 through the input/output unit 22. It should be noted that the same elements in FIGS. 11-12 and FIGS. 1-3 are represented by the same numerals, so the repeated explanation will not be depicted herein again.

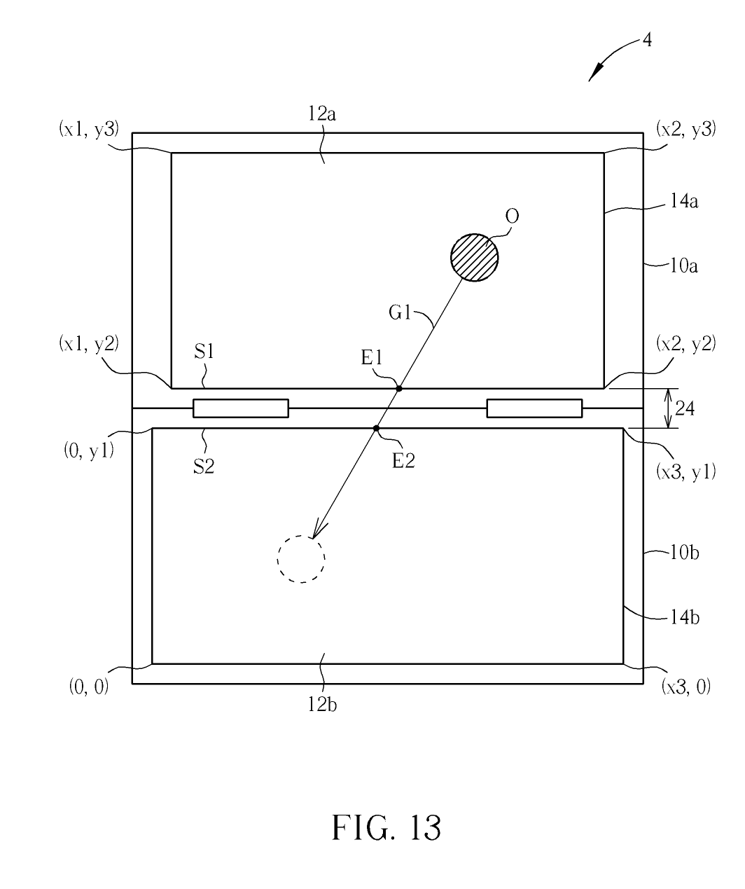

Referring to FIG. 13, FIG. 13 is a schematic diagram illustrating a top view of a touch device 4 according to another embodiment of the invention. The main difference between the touch device 4 and the aforesaid touch device 1 is that the touch areas 14a, 14b of the touch device 4 have different widths and/or lengths. Therefore, the coordinates of four corners of the touch area 14b may be represented by (0,0), (x3,0), (0,y1) and (x3,y1), the coordinates of four corners of the non-touch area 24 maybe represented by (0, y1), (x3,y1), (x1,y2) and (x2,y2), and the coordinates of four corners of the touch area 14a maybe represented by (x1,y2), (x2,y2), (x1,y3) and (x2,y3). In other words, the coordinates of the touch areas 14a, 14b and the non-touch area 24 maybe set according to different sizes of the touch areas 14a, 14b. It should be noted that the same elements in FIG. 13 and FIG. 1 are represented by the same numerals, so the repeated explanation will not be depicted herein again.

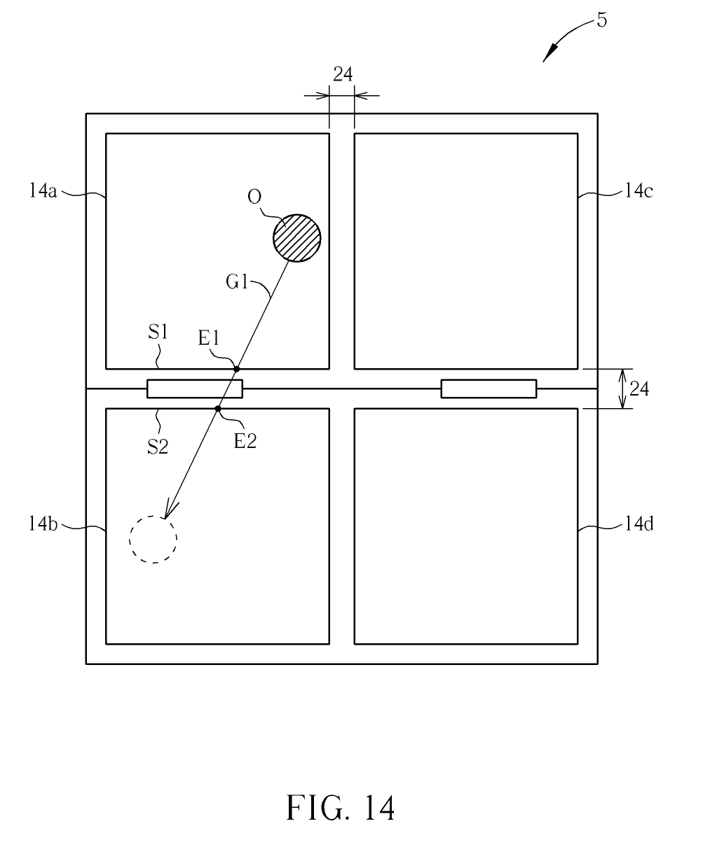

Referring to FIG. 14, FIG. 14 is a schematic diagram illustrating a top view of a touch device 5 according to another embodiment of the present invention. The main difference between the touch device 5 and the aforesaid touch device 1 is that the touch device 5 comprises four touch areas 14a, 14b, 14c and 14d, wherein every two of the four touch areas 14a, 14b, 14c and 14d are arranged adjacent to each other and a non-touch area 24 is located between any two of the four touch areas 14a, 14b, 14c and 14d. The touch methods shown in FIGS. 4 to 6 can be also applied to the touch device 5 shown in FIG. 14. In other words, when the touch device of the invention comprises a plurality of touch areas, the arrangement of the plurality of touch areas is not limited to a straight line.

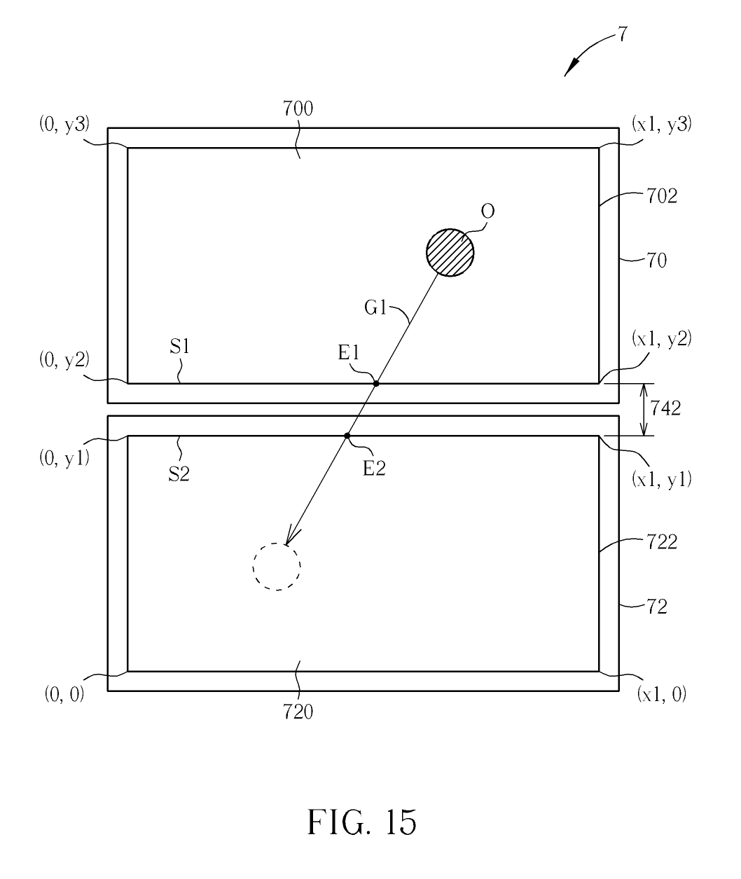

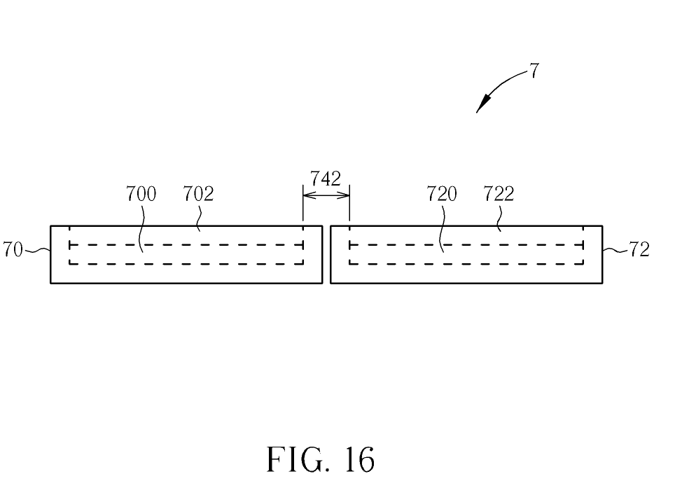

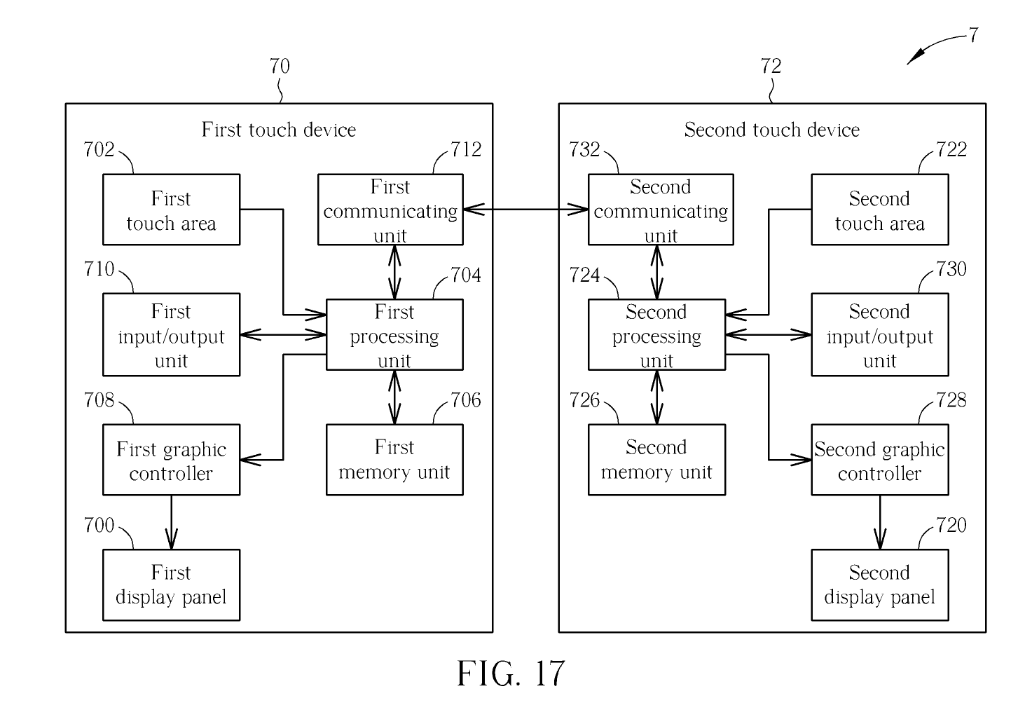

Referring to FIGS. 15 to 17, FIG. 15 is a schematic diagram illustrating a top view of a touch system 7 according to another embodiment of the present invention, FIG. 16 is schematic diagram illustrating a side view of the touch system 7 shown in FIG. 15, and FIG. 17 is a functional block diagram illustrating the touch system 7 shown in FIG. 15. As shown in FIGS. 15 to 17, the touch system 7 comprises a first touch device 70 and a second touch device 72. The first touch device 70 comprises a first display panel 700, a first touch area 702, a first processing unit 704, a first memory unit 706, a first graphic controller 708, a first input/output unit 710 and a first communicating unit 712, wherein the principles of the first display panel 700, first touch area 702, first processing unit 704, first memory unit 706, first graphic controller 708 and first input/output unit 710 are substantially the same as those of the aforesaid display panels 12a, 12b, touch areas 14a, 14b, processing unit 16, memory unit 18, graphic controller 20 and input/output unit 22 and are not depicted herein again. The second touch device 72 comprises a second display panel 720, a second touch area 722, a second processing unit 724, a second memory unit 726, a second graphic controller 728, a second input/output unit 730 and a second communicating unit 732, wherein the principles of the second display panel 720, second touch area 722, second processing unit 724, second memory unit 726, second graphic controller 728 and second input/output unit 730 are substantially the same as those of the aforesaid display panels 12a, 12b, touch areas 14a, 14b, processing unit 16, memory unit 18, graphic controller 20 and input/output unit 22 and are not depicted herein again.

In this embodiment, the first communicating unit 712 and the second communicating unit 732 may be network interface units such that the first touch device 70 and the second touch device 72 can be connected to network through the first communicating unit 712 and the second communicating unit 732 respectively, so as to communicate with each other. In another embodiment, the first communicating unit 712 and the second communicating unit 732 may be wireless communicating modules such as Bluetooth module, WiFi module, infrared module, and can connect to wireless sensor network (WSN), such as Zigbee, or connect to cell phone communication system, such as GSM/GPRS, HSDPA/HSUP and so on. Such that the first touch device 70 and the second touch device 72 can communicate with each other in wireless manner. In another embodiment, the first communicating unit 712 and the second communicating unit 732 may be universal serial bus (USB) connectors or other connectors such that the first touch device 70 and the second touch device 72 can communicate with each other through the first communicating unit 712 and the second communicating unit 732 by a cable. In other words, the first touch device 70 and the second touch device 72 can communicate with each other in wired or wireless manner.

As shown in FIGS. 15 and 16, the second touch device 72 is arranged adjacent to the first touch device 70 such that a non-touch area 742 is located between the first touch area 702 and the second touch area 722. In practical applications, the invention may set specific coordinates on the first touch area 702, the second touch area 722 and the non-touch area 742 for purpose of touch determination. As shown in FIG. 15, the coordinates of four corners of the second touch area 722 are represented by (0,0), (x1,0), (0,y1) and (x1,y1), the coordinates of four corners of the non-touch area 742 are represented by (0,y1), (x1,y1), (0,y2) and (x1,y2), and the coordinates of four corners of the first touch area 702 are represented by (0,y2), (x1,y2), (0,y3) and (x1,y3).

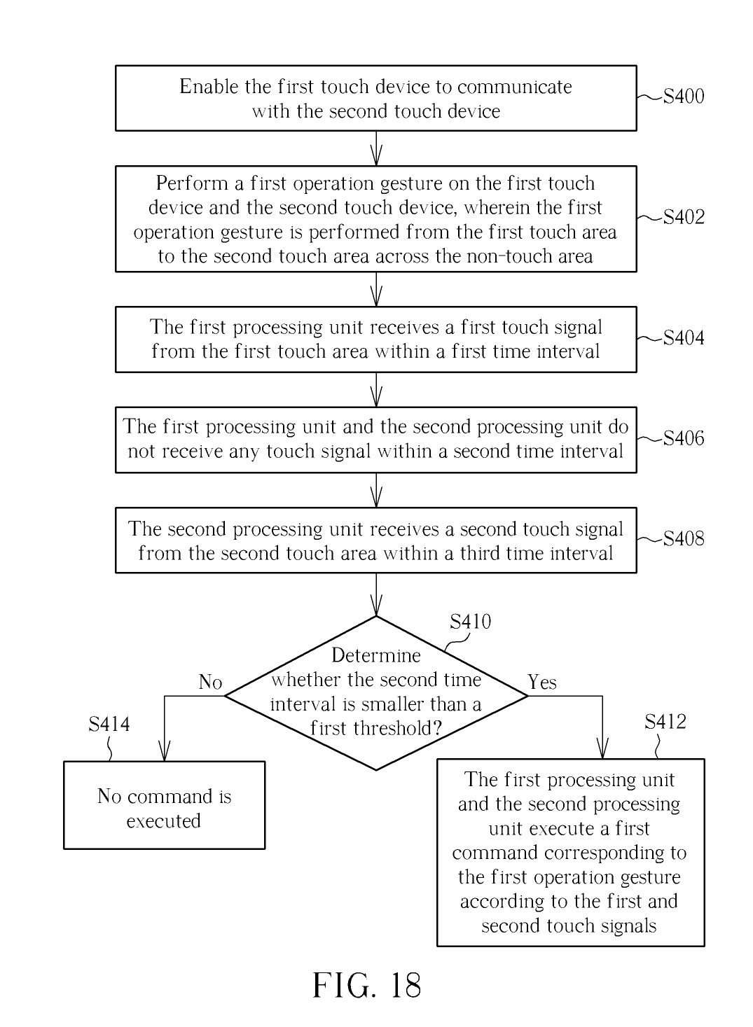

Referring to FIG. 18, FIG. 18 is a flowchart illustrating a touch method according to another embodiment of the present invention. The touch method shown in FIG. 18 may be implemented by programming. The touch system 7 shown in FIGS. 15 to 17 together with the touch method shown in FIG. 18 will be used to describe the features of this embodiment in the following. First of all, step S400 is executed to enable the first touch device 70 to communicate with the second touch device 72. Afterward, step S402 is executed to perform a first operation gesture G1 on the first touch device 70 and the second touch device 72, wherein the first operation gesture G1 is performed from the first touch area 702 to the second touch area 722 across the non-touch area 742. The first processing unit 704 receives a first touch signal from the first touch area 702 within a first time interval (step S404). The first processing unit 704 and the second processing unit 724 do not receive any touch signal within a second time interval (step S406). The second processing unit 724 receives a second touch signal from the second touch area 722 within a third time interval (step S408). In step S404, the first time interval represents the needed time when the first operation gesture G1 moves over the first touch area 702. In step S406, the second time interval represents the needed time when the first operation gesture G1 moves over the non-touch area 742. In step S408, the third time interval represents the needed time when the first operation gesture G1 moves over the second touch area 722. Afterward, in step S410, the first processing unit 704 and the second processing unit 724 determine whether the second time interval is smaller than a first threshold (e.g. 0.5 second). When the first processing unit 704 and the second processing unit 724 determine that the second time interval is smaller than the first threshold, the first processing unit 704 and the second processing unit 724 execute a first command corresponding to the first operation gesture G1 according to the first and second touch signals (step S412). As shown in FIG. 15, the first command is executed to move an object O from the first display panel 700 to the second display panel 720 (as the dotted line shown in FIG. 15). On the other hand, if the first processing unit 704 and the second processing unit 724 determine that the second time interval is not smaller than the first threshold, no command is executed (step S414).

As mentioned in the above, when the first operation gesture G1 crosses the non-touch area 742, the first processing unit 704 and the second processing unit 724 do not receive any touch signal within the second time interval. The touch system 7 and the touch method of the invention determine whether the first operation gesture G1 is a continuous operation gesture based on the second time interval. If the first operation gesture G1 is determined as a continuous operation gesture, the first command corresponding to the first operation gesture G1 is executed according to the touch signals from different touch areas of different touch devices correspondingly. On the other hand, if the first operation gesture G1 is determined as a discontinuous operation gesture, no command is executed correspondingly. Therefore, a plurality of touch devices of the touch system 7 can be integrated into one larger touch device.

It should be noted that the first operation gesture G1 and the corresponding first command can be designed based on practical applications and are not limited to the aforesaid embodiment.

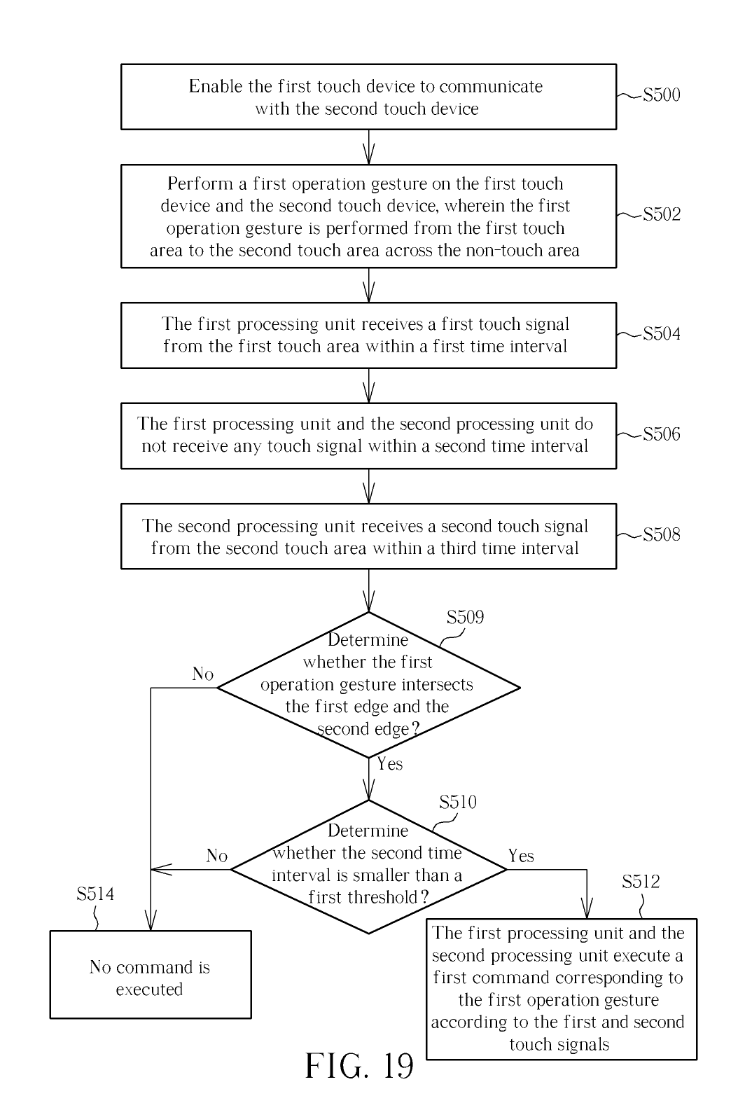

Referring to FIG. 19, FIG. 19 is a flowchart illustrating a touch method according to another embodiment of the present invention. The touch method shown in FIG. 19 may be implemented by programming. The touch system shown in FIGS. 15 to 17 together with the touch method shown in FIG. 19 will be used to describe the features of this embodiment in the following. As shown in FIG. 15, the non-touch area 742 abuts against a first edge S1 of the first touch area 702 and abuts against a second edge S2 of the second touch area 722. Steps S500-S508 shown in FIG. 19 are substantially the same as steps S400-S408 shown in FIG. 18 and are not depicted herein again. After step S408, the first processing unit 704 determines whether the first operation gesture G1 intersects the first edge S1 and the second processing unit 724 determines whether the first operation gesture G1 intersects the second edge S2 (step S509). If the first operation gesture G1 intersects the first edge S1 and the second edge S2, step S510 is then executed. On the other hand, if the first operation gesture G1 does not intersect the first edge S1 or the second edge S2, step S514 is then executed. Steps S510-S514 shown in FIG. 19 are substantially the same as steps S410-S414 shown in FIG. 18 and are not depicted herein again.

In other words, the touch method shown in FIG. 19 determines whether the first operation gesture G1 is a continuous operation gesture based on the second time interval and whether the first operation gesture G1 intersects both the first edge S1 and the second edge S2, so as to determine whether to execute the first command.

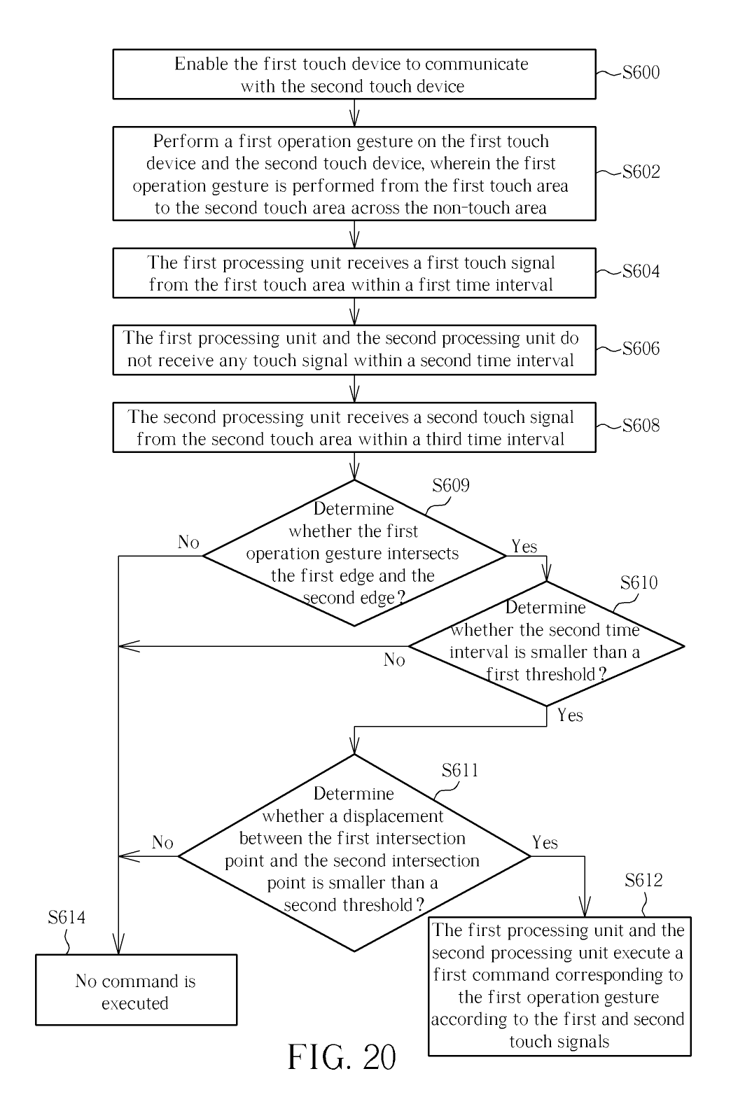

Referring to FIG. 20, FIG. 20 is a flowchart illustrating a touch method according to another embodiment of the present invention. The touch method shown in FIG. 20 may be implemented by programming. The touch system 7 shown in FIGS. 15 to 17 together with the touch method shown in FIG. 20 will be used to describe the features of this embodiment in the following. As shown in FIG. 15, the first operation gesture G1 intersects the first edge S1 at a first intersection point E1 and intersects the second edge S2 at a second intersection point E2. Steps S600-S610 shown in FIG. 20 are substantially the same as steps S500-S510 shown in FIG. 19 and are not depicted herein again. After step S610, the first processing unit 704 and the second processing unit 724 determine whether a displacement between the first intersection point E1 and the second intersection point E2 is smaller than a second threshold (e.g. 3 mm) in step S611. If the displacement between the first intersection point E1 and the second intersection point E2 is smaller than the second threshold, step S612 is then executed. On the other hand, if the displacement between the first intersection point E1 and the second intersection point E2 is not smaller than the second threshold, step S614 is then executed. Steps S612-S614 shown in FIG. 20 are substantially the same as steps S512-S514 shown in FIG. 19 and are not depicted herein again.

In other words, the touch method shown in FIG. 20 determines whether the first operation gesture G1 is a continuous operation gesture based on the second time interval, whether the first operation gesture G1 intersects both the first edge S1 and the second edge S2, and the displacement between the first intersection point E1 and the second intersection point E2, so as to determine whether to execute the first command.

The embodiments shown in FIGS. 7 to 14 can be also applied to the aforesaid touch system 7, so the repeated explanation will not be depicted herein again.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch device comprising:
N touch areas, N being a positive integer larger than 1;
N−1 non-touch areas, an i-th non-touch area of the N−1 non-touch areas being located between an i-th touch area and an (i+1)-th touch area of the N touch areas, i being a positive integer smaller than N; and
a processing unit electrically connected to the N touch areas;
wherein when a first operation gesture is performed from the i-th touch area to the (i+1)-th touch area across the i-th non-touch area, the processing unit receives a first touch signal from the i-th touch area within a first time interval, does not receive any touch signal within a second time interval, and receives a second touch signal from the (i+1)-th touch area within a third time interval; when the processing unit determines that the second time interval is smaller than a first threshold, the processing unit executes a first command corresponding to the first operation gesture according to the first and second touch signals.

2. The touch device of claim 1, wherein the i-th non-touch area abuts against a first edge of the i-th touch area and abuts against a second edge of the (i+1)-th touch area, when the first operation gesture is performed from the i-th touch area to the (i+1)-th touch area across the i-th non-touch area, the processing unit determines whether the first operation gesture intersects the first edge and the second edge; if the first operation gesture intersects the first edge and the second edge and the second time interval is smaller than the first threshold, the processing unit executes the first command corresponding to the first operation gesture according to the first and second touch signals.

3. The touch device of claim 2, wherein the first operation gesture intersects the first edge at a first intersection point and intersects the second edge at a second intersection point, when the processing unit determines that the second time interval is smaller than the first threshold and determines that a displacement between the first and second intersection points is smaller than a second threshold, the processing unit executes the first command corresponding to the first operation gesture according to the first and second touch signals.

4. The touch device of claim 1, wherein when a second operation gesture is performed on the i-th touch area and a third operation gesture is performed on the (i+1)-th touch area, the processing unit receives a third touch signal from the i-th touch area and a fourth touch signal from the (i+1)-th touch area simultaneously and executes a second command corresponding to the second and third operation gestures according to the third and fourth touch signals.

5. The touch device of claim 4, wherein the second and third operation gestures are moving gestures.

6. A touch method comprising:
performing a first operation gesture on the touch device, the touch device comprising N touch areas and N−1 non-touch areas, an i-th non-touch area of the N−1 non-touch areas being located between an i-th touch area and an (i+1)-th touch area of the N touch areas, the first operation gesture being performed from the i-th touch area to the (i+1)-th touch area across the i-th non-touch area, N being a positive integer larger than 1, i being a positive integer smaller than N;
receiving a first touch signal from the i-th touch area within a first time interval;
not receiving any touch signal within a second time interval;
receiving a second touch signal from the (i+1)-th touch area within a third time interval; and
executing a first command corresponding to the first operation gesture according to the first and second touch signals when the second time interval is smaller than a first threshold.

7. The touch method of claim 6, wherein the i-th non-touch area abuts against a first edge of the i-th touch area and abuts against a second edge of the (i+1)-th touch area, the touch method further comprises:
determining whether the first operation gesture intersects the first edge and the second edge when the first operation gesture is performed from the i-th touch area to the (i+1)-th touch area across the i-th non-touch area; and
executing the first command corresponding to the first operation gesture according to the first and second touch signals if the first operation gesture intersects the first edge and the second edge and the second time interval is smaller than the first threshold.

8. The touch method of claim 7, wherein the first operation gesture intersects the first edge at a first intersection point and intersects the second edge at a second intersection point, the touch method further comprises:
executing the first command corresponding to the first operation gesture according to the first and second touch signals when the second time interval is smaller than the first threshold and a displacement between the first and second intersection points is smaller than a second threshold.

9. The touch method of claim 6, further comprising:
performing a second operation gesture on the i-th touch area and performing a third operation gesture on the (i+1)-th touch area;
receiving a third touch signal from the i-th touch area and a fourth touch signal from the (i+1)-th touch area simultaneously; and
executing a second command corresponding to the second and third operation gestures according to the third and fourth touch signals.

10. The touch method of claim 9, wherein the second and third operation gestures are moving gestures.

11. A touch system comprising:
a first touch device comprising a first touch area, a first processing unit and a first communicating unit, the first processing unit being electrically connected to the first touch area and the first communicating unit; and
a second touch device comprising a second touch area, a second processing unit and a second communicating unit, the second processing unit being electrically connected to the second touch area and the second communicating unit, the second communicating unit communicating with the first communicating unit, the second touch device being arranged adjacent to the first touch device such that a non-touch area is located between the first touch area and the second touch area;
wherein when a first operation gesture is performed from the first touch area to the second touch area across the non-touch area, the first processing unit receives a first touch signal from the first touch area within a first time interval, the first and second processing units do not receive any touch signal within a second time interval, and the second processing unit receives a second touch signal from the second touch area within a third time interval; when the first and second processing units determine that the second time interval is smaller than a first threshold, the first and second processing units execute a first command corresponding to the first operation gesture according to the first and second touch signals.

12. The touch system of claim 11, wherein the non-touch area abuts against a first edge of the first touch area and abuts against a second edge of the second touch area, when the first operation gesture is performed from the first touch area to the second touch area across the non-touch area, the first processing unit determines whether the first operation gesture intersects the first edge and the second processing unit determines whether the first operation gesture intersects the second edge; if the first operation gesture intersects the first edge and the second edge and the second time interval is smaller than the first threshold, the first and second processing units execute the first command corresponding to the first operation gesture according to the first and second touch signals.

13. The touch system of claim 12, wherein the first operation gesture intersects the first edge at a first intersection point and intersects the second edge at a second intersection point, when the first and second processing units determine that the second time interval is smaller than the first threshold and determine that a displacement between the first and second intersection points is smaller than a second threshold, the first and second processing units execute the first command corresponding to the first operation gesture according to the first and second touch signals.

14. The touch system of claim 11, wherein when a second operation gesture is performed on the first touch area and a third operation gesture is performed on the second touch area, the first processing unit receives a third touch signal from the first touch area and the second processing unit receives a fourth touch signal from the second touch area, the first and second processing units execute a second command corresponding to the second and third operation gestures according to the third and fourth touch signals.

15. The touch system of claim 14, wherein the second and third operation gestures are moving gestures.

16. A touch method comprising:
enabling a first touch device to communicate with a second touch device, the first touch device comprising a first touch area, the second touch device comprising a second touch area, the second touch device being arranged adjacent to the first touch device such that a non-touch area is located between the first touch area and the second touch area;
performing a first operation gesture on the first and second touch devices, the first operation gesture being performed from the first touch area to the second touch area across the non-touch area;
receiving a first touch signal from the first touch area within a first time interval;
not receiving any touch signal within a second time interval;
receiving a second touch signal from the second touch area within a third time interval; and
executing a first command corresponding to the first operation gesture according to the first and second touch signals when the second time interval is smaller than a first threshold.

17. The touch method of claim 16, wherein the non-touch area abuts against a first edge of the first touch area and abuts against a second edge of the second touch area, the touch method further comprises:
determining whether the first operation gesture intersects the first edge and the second edge when the first operation gesture is performed from the first touch area to the second touch area across the non-touch area; and
executing the first command corresponding to the first operation gesture according to the first and second touch signals if the first operation gesture intersects the first edge and the second edge and the second time interval is smaller than the first threshold.

18. The touch method of claim 17, wherein the first operation gesture intersects the first edge at a first intersection point and intersects the second edge at a second intersection point, the touch method further comprises:
executing the first command corresponding to the first operation gesture according to the first and second touch signals when the second time interval is smaller than the first threshold and a displacement between the first and second intersection points is smaller than a second threshold.

19. The touch method of claim 16, further comprising:
performing a second operation gesture on the first touch area and performing a third operation gesture on the second touch area;
receiving a third touch signal from the first touch area and receiving a fourth touch signal from the second touch area; and
executing a second command corresponding to the second and third operation gestures according to the third and fourth touch signals.

20. The touch method of claim 19, wherein the second and third operation gestures are moving gestures.
